(19) United States
(12) Patent Application Publication
(10) Pub. No.: US 2025/0269501 A1
(43) Pub. Date: Aug. 28, 2025

(54) POWERED RATCHET TOOL WITH WIRE GUIDE INSERT

(71) Applicant: MILWAUKEE ELECTRIC TOOL CORPORATION, Brookfield, WI (US)

(72) Inventors: Evan Brown, Milwaukee, WI (US); Kyle Marten, Plymouth, WI (US); Jordan Gilsinger, Sussex, WI (US); Feng Kun Lu, Dongguan City (CN); Zhi Jie Zhang, Dongguan City (CN)

(21) Appl. No.: 19/061,334

(22) Filed: Feb. 24, 2025

Related U.S. Application Data
(60) Provisional application No. 63/745,849, filed on Jan. 16, 2025.
(60) Provisional application No. 63/557,204, filed on Feb. 23, 2024.

(51) Int. Cl. B25B 21/00; B25F 5/00; B25F 5/02

(52) U.S. Cl. CPC B25B 21/004; B25F 5/001; B25F 5/02

(57) ABSTRACT

A powered ratchet tool including a primary housing, a secondary housing coupled to the primary housing, and a motor supported within the secondary housing. The motor has an output shaft rotatable about a first axis. The powered ratchet tool further includes a ratchet mechanism supported by the secondary housing. The ratchet mechanism is operably coupled to the output shaft of the motor to be driven by the motor. Moreover, the powered ratchet tool includes an insert disposed within the secondary housing and configured to guide a plurality of wires through the secondary housing, and an output drive rotatably supported by the secondary housing. The output drive is operably coupled to the ratchet mechanism. The output drive is configured to be rotated about a second axis perpendicular to the first axis and to receive a tool element.

### CROSS-REFERENCE TO RELATED APPLICATIONS

This application claims priority to U.S. Provisional Patent Application No. 63/745,849, filed Jan. 16, 2025, and U.S. Provisional Patent Application No. 63/557,204, filed Feb. 23, 2024, the entire contents of both of which are incorporated herein by reference.

### FIELD

The present disclosure relates to power tools, and more particularly to powered ratchet tools.

### BACKGROUND

Powered ratchet tools may be driven in a forward direction or an opposite direction to apply torque to a fastener for tightening and loosening operations.

### SUMMARY

The present disclosure provides, in one aspect, a powered ratchet tool including a primary housing, a secondary housing coupled to the primary housing, and a motor supported within the secondary housing. The motor includes an output shaft rotatable about a first axis. The powered ratchet tool further includes a ratchet mechanism supported by the secondary housing. The ratchet mechanism is operably coupled to the output shaft of the motor to be driven by the motor. Moreover, the powered ratchet tool includes an insert disposed within the secondary housing and configured to guide a plurality of wires through the secondary housing, and an output drive rotatably supported by the secondary housing. The output drive is operably coupled to the ratchet mechanism. The output drive is configured to be rotated about a second axis perpendicular to the first axis and to receive a tool element.

The present disclosure provides, in another aspect, a powered ratchet tool including a housing having a handle housing, a gear case at least partially received within the handle housing, and a yoke housing at least partially received within the gear case. The powered ratchet tool further includes a motor supported within the gear case and a ratchet mechanism supported within the yoke housing. The handle housing, the gear case, and the yoke housing are each made of different materials.

The present disclosure provides, in another aspect, a powered ratchet tool including a housing having a handle housing, a gear case at least partially received within the handle housing, and a yoke housing at least partially received within the gear case. The powered ratchet tool further includes a motor supported within the gear case and a ratchet mechanism supported within the yoke housing. The yoke housing is partially insert-molded into the gear case.

### BRIEF DESCRIPTION OF DRAWINGS

FIG. 1 is a side view of a powered ratchet tool according to an embodiment of the present disclosure.

FIG. 2 is a cross-sectional view of the powered ratchet tool of FIG. 1.

FIG. 3 is another cross-sectional view of the powered ratchet tool of FIG. 1.

FIG. 4 is a side view of the powered ratchet tool of FIG. 1 with portions removed.

FIG. 5 is a perspective view of the powered ratchet tool of FIG. 1 with portions removed, the powered ratchet tool includes a yoke housing and an insert.

FIG. 6 is a rear view of the powered ratchet tool of FIG. 1 with portions removed.

FIG. 7 is a perspective view of the yoke housing of FIG. 5.

FIG. 8 is a perspective view of the insert of FIG. 5.

FIG. 9 is a perspective view of a powered ratchet tool according to another embodiment of the disclosure.

FIG. 10 is a cross-sectional view of a portion of the powered ratchet tool of FIG. 9, taken along line 10-10 in FIG. 9.

FIG. 11 is a cross-sectional view of the powered ratchet tool of FIG. 9.

FIG. 12 is a perspective view of an insert of the powered ratchet tool of FIG. 9.

FIG. 13 is a perspective view of a yoke housing of the powered ratchet tool of FIG. 9.

FIG. 14 is a cross-sectional view of a portion of a powered ratchet tool according to another embodiment.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

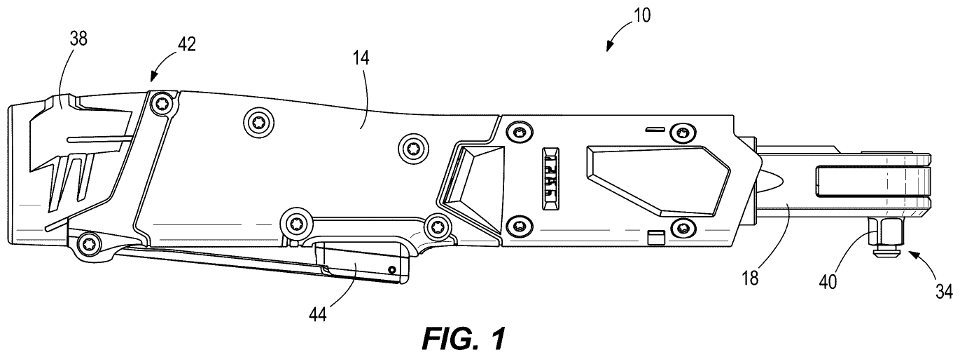

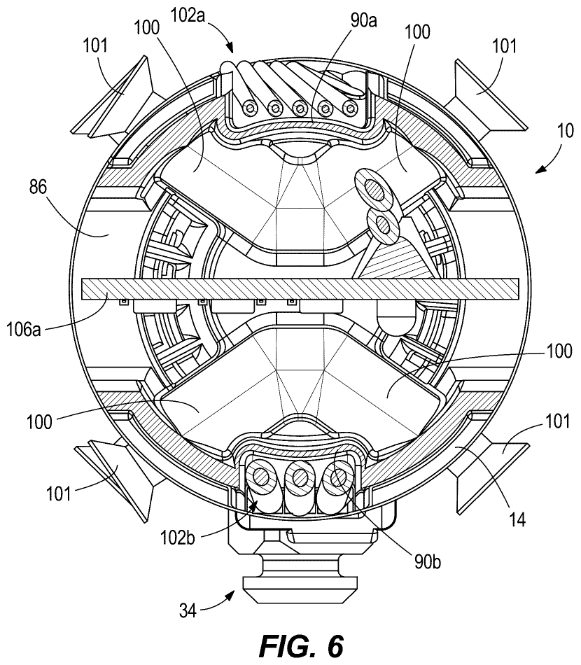

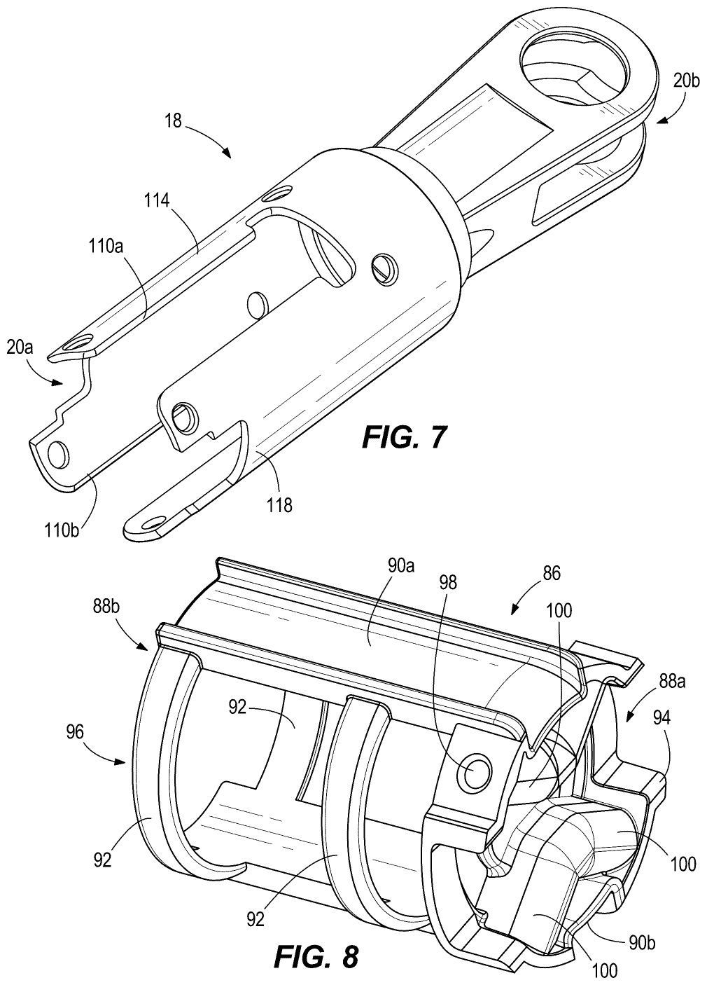

With reference to FIGS. 1-3, a powered ratchet tool 10 in accordance with an embodiment of the disclosure includes a primary housing 14 and a secondary housing or yoke housing 18 coupled to the primary housing 14 by fasteners 101 (FIG. 6). A portion of the yoke housing 18 is received within the primary housing 14. The primary housing 14 is a clamshell housing configured to be grasped by a user during operation, while the yoke housing 18 is a metal housing. The yoke housing 18 has a first end 20a disposed within the primary housing 14 and a second end 20b extending from the primary housing 14 (FIG. 7). The powered ratchet tool 10 further includes a motor 22 that is supported within the yoke housing 18. The motor 22 has an output shaft 26 rotatable about a first axis 30 and is configured to provide torque to an output drive 34 rotatably supported by the yoke housing 18 for rotation about a second axis 36 perpendicular to the first axis 30. The motor 22 is preferably a brushless DC motor. In some embodiments, the motor 22 is a surface permanent magnet (SPM) motor including a stator, a rotor, and permanent magnets affixed to or embedded in an exterior surface of the rotor. In other embodiments, the motor 22 is an outer rotor motor, having a rotor that surrounds and rotates about the stator. The output drive 34 includes a square drive interface 40, preferably with a nominal size (e.g., ⅜″, ½″, ¾″, 1″, etc.). The output drive 34 is configured to be coupled to a tool element (not shown) that performs work on a workpiece (e.g., a fastener, bit, or the like).

In the illustrated embodiment, the ratchet tool 10 includes a battery pack 38 received by a battery receptacle 42 formed in the primary housing 14 opposite the yoke housing 18. The battery receptacle 42 electrically connects the battery pack 38 to the motor 22 (via suitable electrical and electronic components, such as a PCBA containing MOSFETs, IGBTs, or the like). The battery pack 38 may be a 12-volt power tool battery pack that includes three lithium-ion battery cells. Alternatively, the battery pack 38 may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. The ratchet tool 10 also includes an actuator 44 for controlling operation of the ratchet tool 10 (e.g., to energize/de-energize the motor 22). In the illustrated embodiment, the actuator 44 is a push-button that can be depressed into the primary housing 14 to energize the motor 22. The illustrated actuator 44 extends from the primary housing 14 in the same direction as the output drive 34.

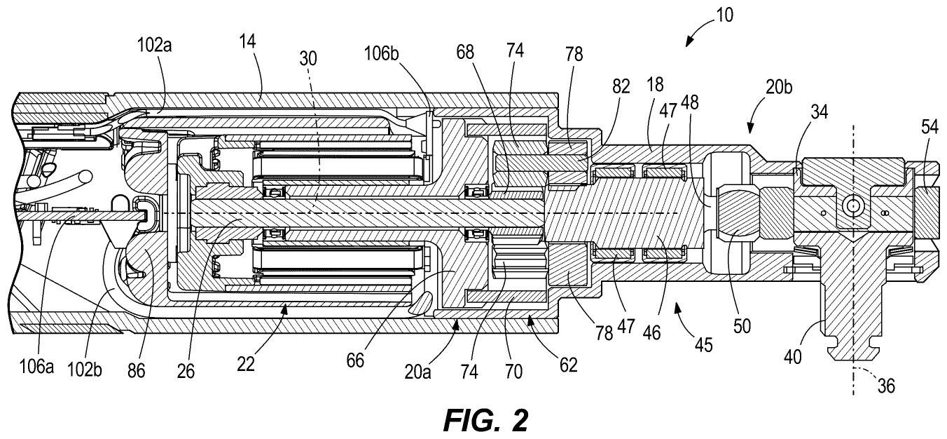

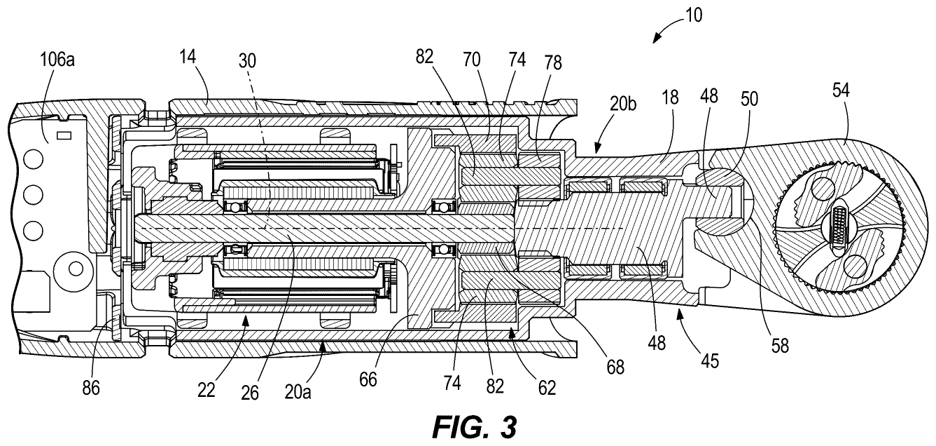

With reference to FIGS. 2 and 3, the powered ratchet tool 10 further includes a ratchet mechanism 45 supported by the second end 20b of the yoke housing 18. The ratchet mechanism 45 has a crankshaft 46 with an eccentric member 48 and a drive bushing 50 arranged on the eccentric member 48 of the crankshaft 46. The crankshaft 46 is rotatably supported by two bearings 47 fixed within the yoke housing 18. The ratchet mechanism 45 further includes a yoke 54 through which the output drive 34 extends. The yoke 54 has a recess 58 in which the drive bushing 50 is arranged. When the crankshaft 46 is rotated, the drive bushing 50 pivots the yoke 54 in a reciprocating manner to drive the output drive 34.

With continued reference to FIGS. 2 and 3, the crankshaft 46 of the ratchet mechanism 45 is operably coupled to the output shaft 26 of the motor 22 via a transmission 62 also supported within the yoke housing 18 to be driven by the motor 22. The transmission 62 includes a first planet carrier 66 extending through a portion of the motor 22 and surrounding the output shaft 26 of the motor 22, a pinion 68, a ring gear 70 coupled to the first planet carrier 66, a plurality of planet gears 74, and a second planet carrier 78. The pinion 68 is coupled to the output shaft 26 of the motor 22 for rotation about the first axis 30. The plurality of planet gears 74 are meshed with both the pinion 68 and the ring gear 70. Pins 82 are used to couple the plurality of planet gears 74 with the second planet carrier 78. The second planet carrier 78 engages the crankshaft 46 to drive rotation of the crankshaft 46 to operate the ratchet mechanism 45.

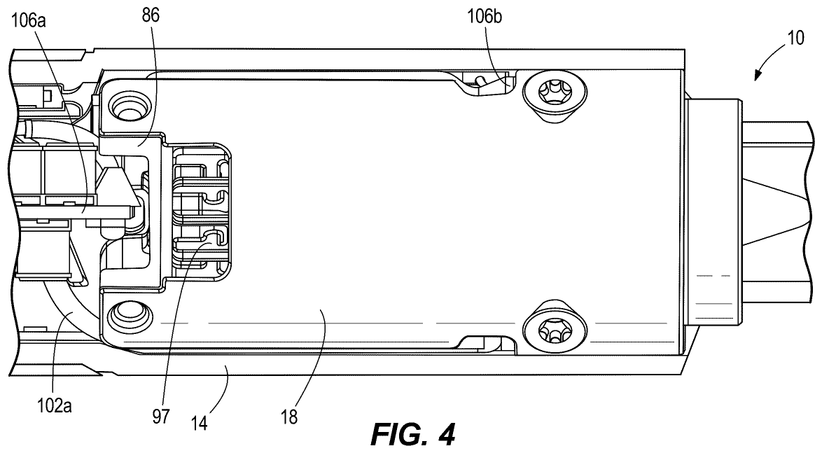

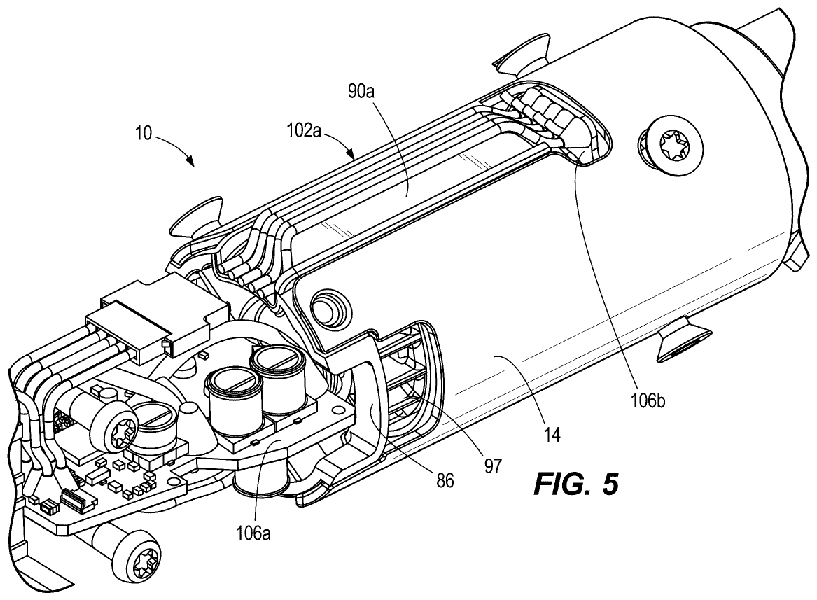

With reference to FIGS. 4-8, the powered ratchet tool 10 also includes an insert 86 disposed at the first end 20a of the yoke housing 18. The insert 86 is formed of a plastic material in the illustrated embodiment but may be made of other materials. The insert 86 has a first end 88a and a second end 88b opposite the first end 88a. The insert 86 defines a first channel 90a and a second channel 90b that are opposite each other and extend between the first and second ends 88a, 88b. The first and second channels 90a, 90b of the insert 86 are configured to provide support at the first end 20a of the yoke housing 18 for a first plurality of wires 102a and a second plurality of wires 102b extending between two PCBs 106a, 106b and the motor 22. The first and second channels 90a, 90b extend in a direction parallel to the first axis 30, and thereby provides a path for the first and second plurality of wires 102a, 102b to guide the wires 102a, 102b through the yoke housing 18.

With reference to FIG. 8, the insert 86 also includes a plurality of channel arms 92 and an end portion 94. The channel arms 92 are coupled to and extend between the first channel 90a and the second channel 90b to interconnect the channels 90a, 90b together. Each channel arm 92 has an arcuate shape so that the insert 86 is shaped and sized to fit within the yoke housing 18. The channel arms 92 are spaced from each other such that a gap is formed between adjacent channel arms 92. The end portion 94 is coupled to the first channel 90a and the second channel 90b at the first end 88a of the insert 86. As such, the insert 86 defines a space 96 between the first channel 90a, the second channel 90b, the plurality of channel arms 92, and the end portion 94. The motor 22 is configured to be received within the space 96 to be supported by the insert 86, and in turn, supported by the yoke housing 18. An impeller 97, that is provided for cooling the motor 22, is arranged rearward of the motor 22 and received within the space 96 of the insert 86.

In addition, the insert 86 includes multiple fastening holes 98 defined within the end portion 94. It should be assumed that the insert 86 has multiple fastening holes 98, even though only one fastening hole 98 is illustrated in FIG. 8. More specifically, each fastening hole 98 is defined within a respective fastener arm 100 formed on the end portion 94 of the insert 86. The fastener arms 100 are configured to receive the fasteners 101 that couple the yoke housing 18 coupled to the primary housing 14.

The yoke housing 18 defines a first window 110a along a top portion 114 of the yoke housing 18 and a second window 110b along a bottom portion 118 of the yoke housing 18. The insert 86 is arranged within the yoke housing 18 such that the first channel 90a is exposed through the first window 110a of the yoke housing 18 and the second channel 90b is exposed through the second window 110b of the yoke housing 18. The first and second channels 90a, 90b of the insert 86 are shaped and sized to respectively fit within the first and second windows 110a, 110b of the yoke housing 18.

In operation, the user depresses the actuator 44 to energize the motor 22 and rotate the output shaft 26. The pinion 68 co-rotates with the output shaft 26 to rotate the plurality of planet gears 74, and thereby rotate the second planet carrier 78 to drive rotation of the crankshaft 46. The crankshaft 46 rotates the drive bushing 50, which causes the yoke 54 to pivot in a reciprocating manner relative to the yoke housing 18. The yoke 54 then transfers torque to the output drive 34 to either tighten or loosen a workpiece.

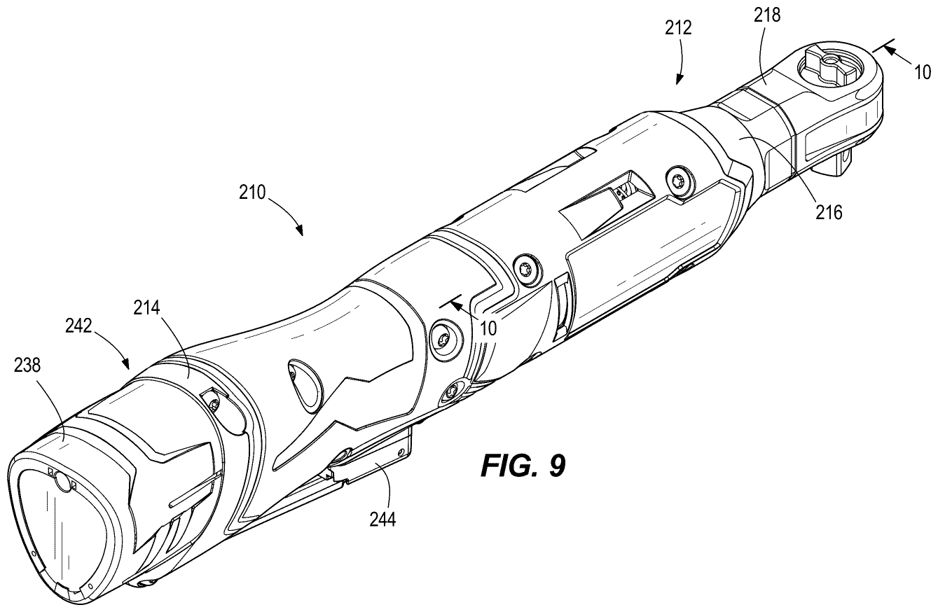

FIGS. 9-11 illustrated a powered ratchet tool 210 according to another embodiment. The powered ratchet tool 210 is similar in some aspects to the powered ratchet tool 10 of FIGS. 1-8 described above, and features of the powered ratchet tool 210 corresponding with features of the powered ratchet tool 10 are given like reference numerals plus ‘200.’ In addition, the following description focuses primarily on differences between the powered ratchet tool 210 and the powered ratchet tool 10, and it should be understood that features of the powered ratchet tool 10 may be incorporated into the powered ratchet tool 210, and vise versa.

With reference to FIGS. 9-12, the powered ratchet tool 210 includes a housing 212, which, in the illustrated embodiment, includes a handle housing 214, a gear case 216, and a yoke housing 218. A portion of the gear case 216 is received within the handle housing 214, and a portion of the yoke housing 218 is received within the gear case 216.

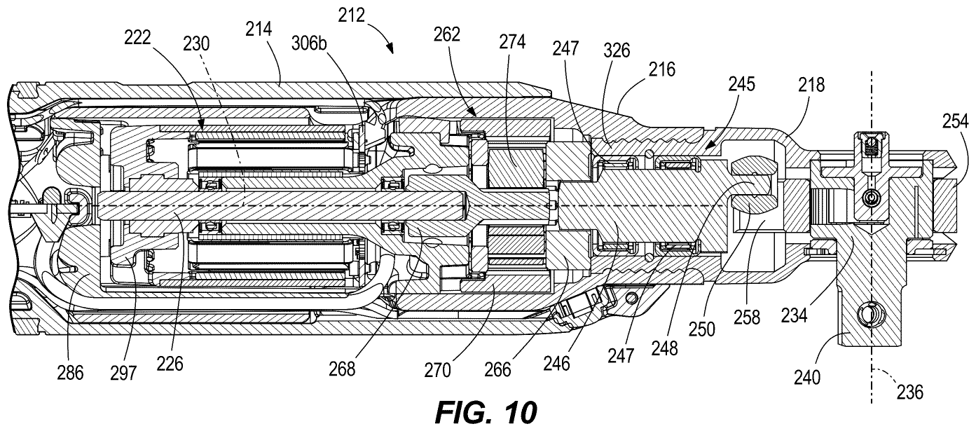

Referring to FIG. 10, a motor 222 is supported within the gear case 216. The motor 222 has an output shaft 226 rotatable about a first axis 230 and is configured to provide torque to an output drive 234 rotatably supported by the yoke housing 218 for rotation about a second axis 236 perpendicular to the first axis 230. The motor 222 is an outer rotor motor in the illustrated embodiment, having a rotor that surrounds and rotates about the stator. The output drive 234 includes a square drive interface 240 but may have other drive interfaces in other embodiments. The output drive 234 is configured to be coupled to a tool element (e.g., a socket; not shown) that performs work on a workpiece (e.g., a fastener, bit, or the like). In further embodiments, the output drive 234 may include an internal recess having a polygonal cross-sectional shape and configured to receive the tool element. In additional embodiments, the output drive 234 and the tool element may include cooperating spline geometries. The ratchet tool 10 also includes a battery pack 238 received by a battery receptacle 242 formed in the handle housing 214 opposite the yoke housing 218. An actuator 244 is provided for controlling operation of the ratchet tool 210 (e.g., to energize/de-energize the motor 222) and is a push-button that can be depressed into the handle housing 214 to energize the motor 222.

With continued reference to FIG. 10, the powered ratchet tool 210 includes a ratchet mechanism 245 supported by the yoke housing 218. The ratchet mechanism 245 has a crankshaft 246 with an eccentric pin 248 and a drive bushing 250 arranged on the eccentric pin 248. The crankshaft 246 is rotatably supported by two bearings 247 fixed within the yoke housing 218. The ratchet mechanism 245 further includes a yoke 254 through which the output drive 234 extends. The yoke 254 has a recess 258 in which the drive bushing 250 is arranged. When the crankshaft 246 is rotated, the drive bushing 250 pivots the yoke 254 in a reciprocating manner to drive the output drive 234.

With continued reference to FIG. 10, the crankshaft 246 of the ratchet mechanism 245 is operably coupled to the output shaft 226 of the motor 222 via a transmission 262 supported within the gear case 216 to be driven by the motor 222. The transmission 262 includes a planet carrier 266, a pinion 268, a ring gear 270, and a plurality of planet gears 274. The pinion 268 is coupled to the output shaft 226 of the motor 222 for rotation about the first axis 230. The plurality of planet gears 274 are meshed with both the pinion 268 and the ring gear 270. The ring gear 270 is fixed within the gear case 216 (e.g., via a press-fit or any other suitable method, such as insert-molding). The planet carrier 266 engages the crankshaft 246 (e.g., via a spline connection, press-fit, or any other suitable connection) to drive rotation of the crankshaft 246 to operate the ratchet mechanism 245.

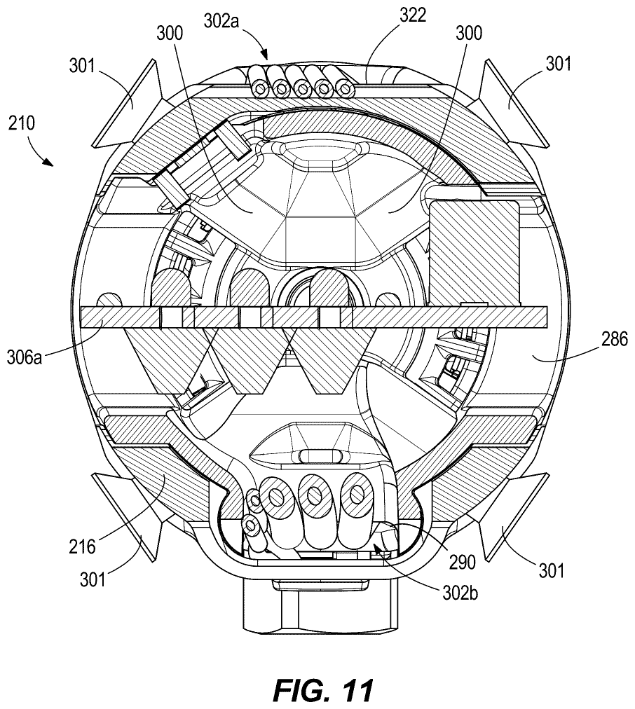

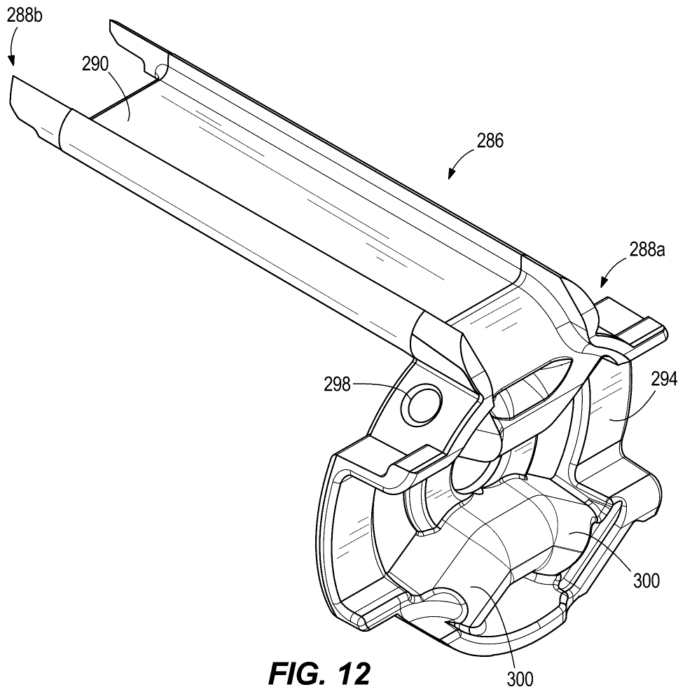

With reference to FIGS. 11 and 12, The powered ratchet tool 210 also includes an insert 286 formed of a plastic material in the illustrated embodiment but may be made of other materials. The insert 286 has a first end 288a and a second end 288b opposite the first end 288a. The insert 286 defines a channel 290 arranged opposite a flat surface 322 formed on the gear case 216. The channel 290 extends between the first and second ends 288a, 288b of the insert 286. The channel 290 of the insert 286 and the flat surface 322 of the gear case 216 are configured to provide support for a first plurality of wires 302a and a second plurality of wires 302b extending between two PCBs 306a, 306b and the motor 222. The channel 290 and the flat surface 322 extend in a direction parallel to the first axis 230, and thereby provide a path for the first and second plurality of wires 302a, 302b to guide the wires 302a, 302b through and along the gear case 216. In other embodiments, all or a portion of the insert 286 may be formed of a material (e.g., aluminum) that provides additional strength in comparison to the plastic material. As such, at least a portion of the insert 286 in such embodiments is stiffer than the material of the handle housing 214. This portion of the insert 286 may be separate from or integral with the channel 290.

The housing 212 of the powered ratchet tool 210 is constructed for improved strength and rigidity compared to typical powered ratchet tools, which often include a metal yoke housing coupled to a plastic handle housing. This in turn may enhance the ability of the powered ratchet tool 210 to manually apply torque to a fastener by grasping and rotating the housing 212 about the second axis 236.

The illustrated handle housing 214 is a clamshell housing configured to be grasped by a user during operation and is made of plastic. The gear case 216 and the yoke housing 218 are made of metal. For example, in the illustrated embodiment, the gear case 216 is made of aluminum (e.g., by die casting). The yoke housing 218 is made of steel (e.g., by machining, forging, or die casting). Thus, in the illustrated embodiment, handle housing 214, the gear case 216, and the yoke housing 218 are each made of different materials.

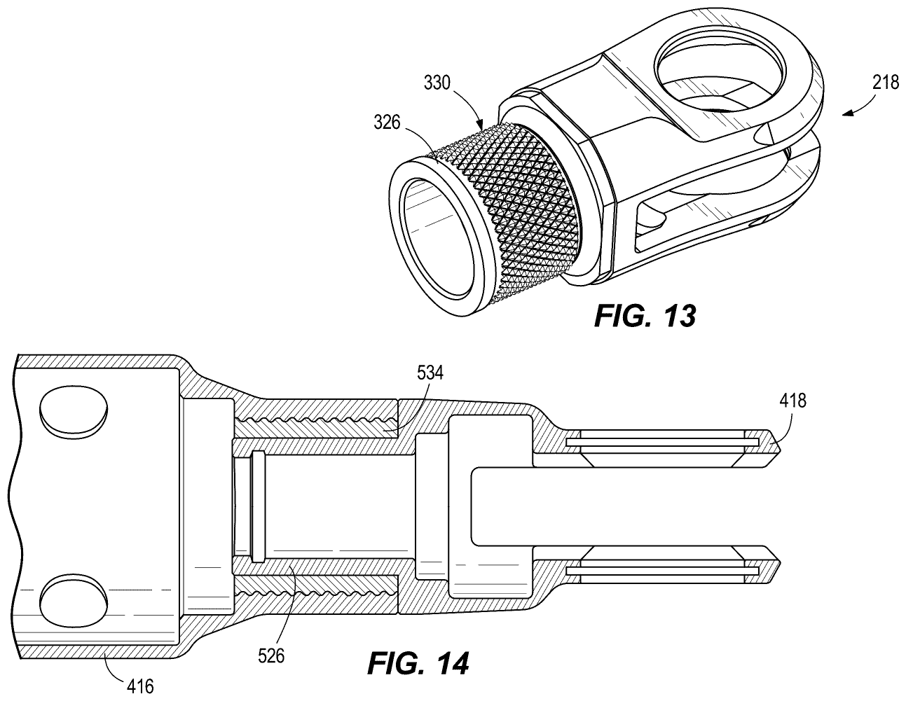

The yoke housing 218 is insert-molded into the gear case 216 in the illustrated embodiment. That is, the gear case 216 is die cast around the yoke housing 218 to couple the yoke housing 218 to the gear case 216 with a strong and fastener-free connection. In the illustrated embodiment, the yoke housing 218 includes a tubular neck 326 with a knurled texture 330 on its outer surface (FIG. 13). The knurled texture 330 may provide increased surface area and bonding between the gear case 216 and the yoke housing 218.

FIG. 14 illustrates another embodiment of a yoke housing 418 and a gear case 416 which may be incorporated into the powered ratchet tool 210. The illustrated yoke housing 418 includes a bushing 534 having a knurled texture on its outer surface. The bushing 534 is separate from the remainder of the yoke housing 418 and is insert-molded into the gear case 416. The bushing 534 may be made of steel. Once the bushing 534 is molded into the gear case 416, the remainder of the yoke housing 418 (e.g., a body or the tubular neck 526 of the yoke housing 418) is pressed into the bushing 534. As such, the tubular neck 526 of the illustrated yoke housing 418 has a smooth outer surface. By providing the knurled texture on the bushing 534 rather than the body of the yoke housing 418, manufacturing of the yoke housing 418 may be simplified. In addition, because only the bushing 534 is insert-molded into the gear case 416, the mold may be simplified.

Although the disclosure has been described in detail with reference to certain preferred embodiments, variations and modifications exist within the scope and spirit of one or more independent aspects of the disclosure as described.

Various features and aspects of the disclosure are set forth in the following claims.

What is claimed is:

1. A powered ratchet tool comprising:
a primary housing;
a secondary housing coupled to the primary housing;
a motor supported within the secondary housing, the motor including an output shaft rotatable about a first axis;
a ratchet mechanism supported by the secondary housing, the ratchet mechanism operably coupled to the output shaft of the motor to be driven by the motor;
an insert disposed within the secondary housing and configured to guide a plurality of wires through the secondary housing; and
an output drive rotatably supported by the secondary housing and operably coupled to the ratchet mechanism, the output drive configured to be rotated about a second axis perpendicular to the first axis and to receive a tool element.

2. The powered ratchet tool of claim 1, wherein the insert is formed of a plastic material.

3. The powered ratchet tool of claim 1, wherein the insert defines a channel extending in a direction parallel to the first axis and configured to guide the plurality of wires through the secondary housing.

4. The powered ratchet tool of claim 3, wherein the secondary housing defines a window, and wherein the channel is exposed through the window.

5. The powered ratchet tool of claim 3, wherein the channel is a first channel and the plurality of wires is a first plurality of wires, and wherein the insert defines a second channel opposite the first channel and configured to guide a second plurality of wires through the secondary housing.

6. The powered ratchet tool of claim 5, wherein the secondary housing defines a first window and a second window, and wherein the first channel is exposed through the first window and the second channel is exposed through the second window.

7. The powered ratchet tool of claim 1, wherein the insert is formed of aluminum.

8. The powered ratchet tool of claim 1, further comprising a transmission supported by the secondary housing and configured to operably couple the ratchet mechanism to the output shaft of the motor.

9. A powered ratchet tool comprising:
a housing including
a handle housing,
a gear case at least partially received within the handle housing, and
a yoke housing at least partially received within the gear case;
a motor supported within the gear case; and
a ratchet mechanism supported within the yoke housing,
wherein the handle housing, the gear case, and the yoke housing are each made of different materials.

10. The powered ratchet tool of claim 9, wherein the handle housing is made of plastic, and wherein the gear case and the yoke housing are made of metal.

11. The powered ratchet tool of claim 10, wherein the gear case is made of aluminum and the yoke housing is made of steel.

12. The powered ratchet tool of claim 9, further comprising an insert disposed within the gear case and configured to guide a plurality of wires through the gear case.

13. The powered ratchet tool of claim 12, wherein the insert defines a channel configured to guide the plurality of wires.

14. The powered ratchet tool of claim 9, wherein the yoke housing has a tubular neck with a knurled texture.

15. The powered ratchet tool of claim 9, further comprising a transmission supported by the gear case and configured to operably couple the ratchet mechanism to the motor.

16. A powered ratchet tool comprising:
a housing including
a handle housing,
a gear case at least partially received within the handle housing, and
a yoke housing at least partially received within the gear case;
a motor supported within the gear case; and
a ratchet mechanism supported within the yoke housing,
wherein the yoke housing is partially insert-molded into the gear case.

17. The powered ratchet tool of claim 16, wherein the yoke housing includes a bushing insert-molded into the gear case and a body pressed into the bushing.

18. The powered ratchet tool of claim 17, wherein the bushing has an outer surface with a knurled texture.

19. The powered ratchet tool of claim 17, wherein the bushing is made of steel.

20. The powered ratchet tool of claim 16, further comprising an insert disposed within the gear case and configured to guide a plurality of wires through the gear case.
